(19) United States
(12) Patent Application Publication
(10) Pub. No.: US 2009/0250243 A1
(43) Pub. Date: Oct. 8, 2009

(54) Arc resistant and smooth wire

(76) Inventors: Wei Zhu, Wilson, NC (US); Jun Hong Yi, Wilson, NC (US)

Correspondence Address: SOFER & HAROUN LLP., 317 MADISON AVENUE, SUITE 910, NEW YORK, NY, 10017, US

(21) Appl. No.: 12/315,621

(22) Filed: Dec. 4, 2008

Related U.S. Application Data
(60) Provisional application No. 61/005,715, filed on Dec. 7, 2007.
(60) Provisional application No. 61/131,629, filed on Jun. 10, 2008.

(51) Int. Cl. H01B 7/00

(52) U.S. Cl. 174/120 R

(57) ABSTRACT

A wire is constructed having a conductor, a primary insulation layer and a secondary insulation layer. A third insulation layer is applied over the second insulation layer, where the third insulation layer includes the only marking additives used in the three insulation layers of the wire.

### RELATED APPLICATIONS

This application claims the benefit of priority from U.S. Provisional Patent Application No. 61/005,718, filed on Dec. 7, 2007 and U.S. Provisional Patent Application No. 61/131,629, filed on Jun. 10, 2008, the entirety of which are incorporated by reference.

### FIELD OF THE INVENTION

This application relates to cable construction. More particularly, the present invention relates to a layered insulation for cables.

### BACKGROUND

In the field of high performance airframe wires, such as those used in commercial and military airplanes, these wires must meet stringent performance ratings. Generally, improving the performance attributes while maintaining or reducing the weight of the wire is a primary goal in the industry.

Some of the critical performance attributes that must be maintained by the wire/insulation combination include thermal mechanical performance, arc resistance, UV-Laser mark-ability, abrasion resistance, dynamic cut-through resistance and smooth surfacing.

In the prior art, polyimide tapes, including pure polyimide tapes and Teflon™ (fluoropolymer) coated polyimide tapes, have been used as primary insulators. The polyimide provides a number of advantageous properties, including good mechanical and insulating properties. However, the polyimides need to be applied as tapes instead of by melt extrusion processing because the high molecular weight polyimidies, needed for the performance characteristics, make it very difficult to extrude.

These polyimide tapes, aside from the majority of their advantageous properties, do suffer from poor dry and wet arc resistance tracking. Although later versions of the polyimidie tapes have fluoropolymer coatings with improved arc tracking, they are still not ideal for meeting the desired arc resistance standards.

Fluoropolymers (including Teflon™) are known to have a good arc resistance properties and are thus commonly used in a second layer over the primary insulation in wires for airframe applications. For example unsintered PTFE (Polytetrafluoroethylene-Teflon™) tapes may be applied over the primary polyimide insulation. An Example of the prior art cable according to this construction, such as an airframe wire according to the industry standard AS22759/80-82, and 86-92, is found in FIG. 1.

However, another concern with airframe wires is the desire that they be both smooth and printable (e.g. using UV laser printing). In order to make the outer PTFE layer printable, additives, particularly titanium dioxide, and other related materials (pigments) are added to the PTFE insulation tape. These added materials, although they allow for easy UV laser marking, often times reduce other essential properties of the cable, including arc resistance properties. For example, the common additive of titanium dioxide is used because it enhances the UV laser markability (enhances marking contrast level) of fluoropolymers (PTFE), but it is also good at sustaining electrical arcs and thus simultaneously reduces the arc resistance of the wire.

Another one of the performance attributes that is desirable in this industry is a smooth surface wire which at least maintain the current AS22759/80-82, and 86-92 performance levels (industry standards for airframe cables). However, because of the tape constructions, the wire are not edgeless and smooth and because of the impurities added to the PTFE for marking purposes as noted above, they do not perform well in the wet arc resistance tests. Thus, due to these limitations typical current specifications for air frame wires only require that the wire pass “wet-arc track” at 90% and 85% for medium and thin wall respectively.

### OBJECTS AND SUMMARY

The present invention overcomes the drawbacks associated with the prior art by providing a wire having a conductor coated with a primary insulation layer and a secondary insulation layer. Over the secondary insulation layer a third thin layer is applied, where this third layer is provided with a various marking an color additives so as to make the outer surface both smooth and markable as well as to remove the need for placing such additives in the primary and secondary insulation layers.

By separating and restricting the UV laser marking and coloring functionality to the outside layer of the insulation system of the wire, the overall insulation system may be formulated for improved mechanical and electrical performance. For example, doping only the outer thin third layer of PTFE insulation with titanium dioxide and coloring additives and leaving the secondary insulation layer as natural (pure and free of additives) PTFE.

In one arrangement of the invention, the doping of the thin third layer of insulation may be achieved by adding the third layer through melt extrusions, wrapping, coating or by treating the outer surface of secondary insulation layer by other means. One example, is a fusion process where the UV laser sensitizer (titanium dioxide) and the coloring additives are added to the outer third layer of insulation.

By separating the outer third marking layer (or coating insulation layer) from the secondary insulation layer, this allows the secondary layer to be made without the need for marking additives, allowing for even better overall arc resistance of the total insulation layer. In fact, the pure PTFE secondary insulation tape may be made thinner allowing for more latitude in the formation of the primary insulation layer, such as in the composition of the tape used.

Furthermore, this improved arc tracking performance from the PTFE secondary insulation layer, allows for the overall polyimide concentration in the insulation of the wire, such as the polyimide component of the primary insulation tape layer relative to the fluoropolymer component, to be increased, thus achieving better thermal and mechanical performance without compromising the arc resistance performance.

Such characteristics allow for greater design choice in meeting certain desired mechanical characteristics while still being able to pass the necessary performance standards. For example, this arrangement enables the cable to pass arc resistance testing at the rate of 95% and higher and meet other requirement of AS22759/80-/82 and AS22759/86-/92.

To this end, the present invention provides for a wire having a conductor, a primary insulation layer and a secondary insulation layer. A third insulation layer is applied over said second insulation layer, where said third insulation layer includes the only marking additives used in the three insulation layers of said wire.

### BRIEF DESCRIPTION OF THE DRAWINGS

The present invention can be best understood through the following description and accompanying drawings, wherein:

FIG. 1 is a prior art airframe wire (AS22759/80-82, 86-92);

FIG. 2 illustrates a multi-layer insulation air frame cable, in accordance with one embodiment of the present invention; and

FIG. 3 illustrates a multi-layer insulation air frame cable, in accordance with another embodiment of the present invention.

### DETAILED DESCRIPTION

In one embodiment of the present invention, a wire (or cable) 10 is provided having a conductor core 12 and insulation layer 20. As noted above, wire 10 is typically for use in airframe applications, however the invention is not limited in this respect.

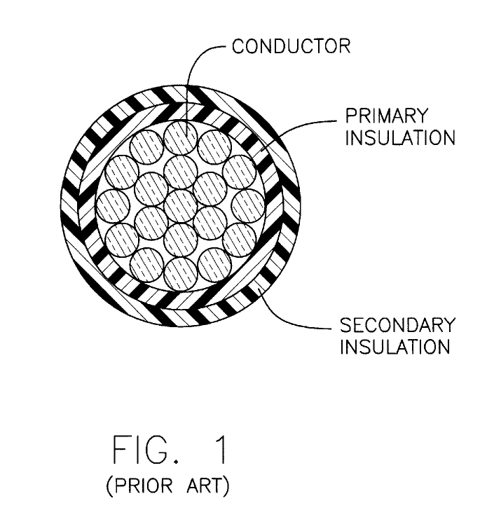

Conductor core 12 for wire 10 as shown in FIG. 1, is a plurality of stranded conductor elements 14. To illustrate the salient features of the present invention, each conductor element 14 is comprised of 19 strands of 32 AWG nickel plated copper (19×32, 20 American Wire Gauge NPC conductor). However, it is understood that individual conductor elements 14 may be made from any other conductor materials that are suitable for the desired application. Moreover, the features of the present invention related to the insulation layer 20, described below, may be applied to single conductor core 12 of solid (only one element) construction.

In one embodiment of the present invention, as shown in FIG. 1, insulation layer 20 is comprised of a first primary insulation layer 22, a secondary insulation layer 24 and a coating layer 26.

In one arrangement, primary insulation layer 22 is preferably formed using composite tape (e.g. DuPont™ 120 TW T 561) having an overall thickness of substantially 0.0012.″ Such a tape may be constructed of a polyimide substrate coated with modified PTFE (Polytetrafluoroethylene) on both sides of the polyimide base. In another arrangement, a tape used for primary insulation layer may simply be an un-coated polyimide tape.

In one arrangement of the present invention, to form layer 22, such a tape is helically wrapped at substantially 51%-54% overlap, preferably 53% overlap, over conductor core 12. The wrapping at about 50% overlap translates into a thickness of primary insulation layer being approximately two times the thickness of the tape. Such a design for primary insulation later 22 is used in exemplary fashion to demonstrate the salient features of the invention. However, it is understood that other manners of applying primary insulation layer 22 to conductor core 12 may also be utilized within the context of the present invention.

Secondary insulation layer 24, is preferably formed using a wrapped tape made from natural unsintered PTFE which is substantially 0.0015″-0.0020″ in thickness, but may be in the range of 0.0005″-0.004″. Ideally, tapes used for secondary insulation layer 24 are made of natural PTFE with no additives, however they may be made from modified PTFE with additives of 4% or less of titanium dioxide and/or 10% or less of other additives by weight. Such tapes may be in the form of skived, unsintered cast or expanded form. Although ideally, the PTFE tape would have no additives to take advantage of the benefits provided by the third insulation layer 26 as explained below, it is possible that some small amount of additives (or possible impurities) may still be present without compromising the benefits of the present invention.

Like the tape from primary layer 22, this tape is also helically wrapped at substantially 51%-54% overlap, preferably 53% overlap, over primary insulation layer 22. Unlike the prior art, secondary insulation layer does not contain any additives, such as marking additives and thus provides very high arc-resistance properties to over all cable insulation 20. Such a design for secondary insulation later 24 is used in exemplary fashion to demonstrate the salient features of the invention. However, as with primary insulation layer 22, it is understood that other manners of applying secondary insulation layer 24 over primary insulation layer 22 may also be utilized within the context of the present invention.

In one embodiment of the present invention, a third insulation layer 26 is applied over the outside of secondary insulation layer 24. Advantageously, it may be applied by means of a fusion where the PTFE is applied using a surface treatment and then fused to the outer surface of secondary insulation layer 24. In this arrangement, third insulation layer 26 is preferably applied in several iterations, each iteration preferably being a layer of substantially 0.0001″-0.0004″ in thickness. Each application iteration may be in the range of 0.00005″-0.001″. It is also understood that third layer 26 may also be applied in other manners, such as melt extrusions, wrapping or coating.

The fusion coating material (PTFE fusion coating layer 26) is formulated to give color to the wire, and to have wire 10 UV laser printable on its surface. For this purpose, the PTFE layer may include the marking additives, such as titanium dioxide. Although this has the above identified drawbacks associated with arc resistance properties, this impact is minimized because third insulation layer 26 is so small relative to the overall thickness of secondary insulation layer 24. Moreover, outer coating or third insulation layer 26, being applied by fusion coating, has the additional advantage that it smoothes over the helical indentations in secondary insulation (which is a wrapped PTFE tape) which not only makes it easier for marking, but also removes the edges (caused by the wrapping of the tape) so as to improve abrasion resistance and to avoid instances of the tape insulation being caught or unwound accidentally by physical environmental hazards.

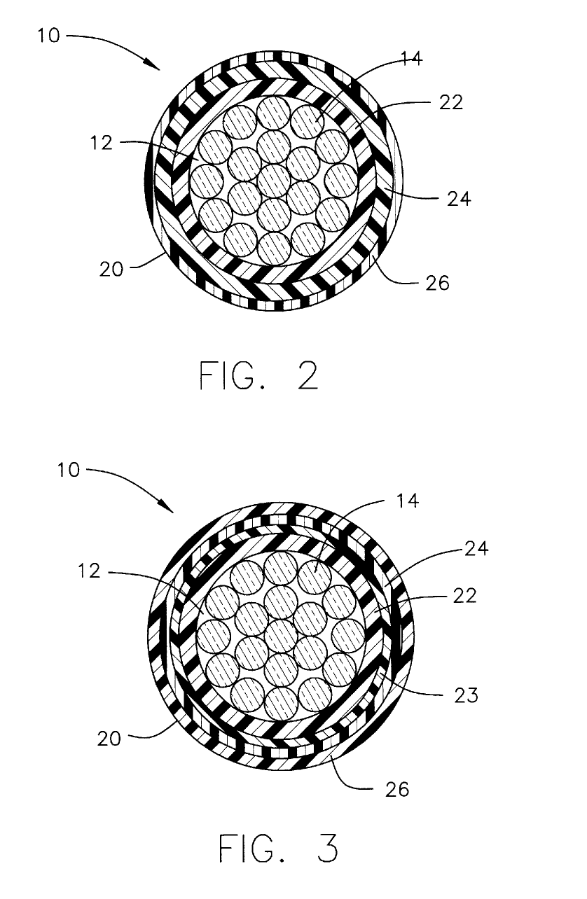

In another embodiment of the present invention, using the same illustration from FIG. 2, primary insulation layer 22 is made from a tape having a polyimide substrate that is coated with modified PTFE on both sides of the polyimide base film. This tape may then be helically wrapped at substantially 63%-70% overlap, preferably 65% overlap, over conductor core 12. In this arrangement, the wrapping of the tape for primary insulation layer 22 at substantially 65% overlap, not only results in an overall thickness of primary insulation layer to be three times the thickness of the tape, but it also results in a more smoothly contoured outer surface.

Secondary insulation layer 24, wrapped thereover, is formed from natural unsintered PTFE tape which is substantially 0.0015″ in thickness or less. Again, this tape is helically wrapped at substantially 65% overlap over primary insulation layer 22. Because secondary insulation layer 24 is made of pure PTFE with no marking additives, it may be made using a lesser thickness than normal because it can achieve the desired insulation and mechanical properties with lesser thickness owing to its pure, non-marking additives formulation. Additionally, the winding at substantially 65% results in a more smoothly contoured outer surface.

As with the first arrangement, an third coating layer 26 is applied as a final outer layer over primary insulation layer 24 for example, by means of PTFE fusion coating described above. This third insulation layer 26 may be applied in several iterations, each of substantially 0.0001″-0.0004″ in thickness.

In another embodiment of the present invention, wire 10 has identical conductor core 12, primary insulation layer 22 and secondary insulation layer 24 as shown in FIG. 2. In this embodiment, third insulation layer (or coating layer) 26 is a helically wrapped PTFE tape of substantially 0.0015″ thickness, applied at substantially 10% overlap. As with the above described third insulation layer 26, the PTFE used for this layer is formulated to give color to wire 10 and to have wire 10 UV laser printable on its surface, such as by the inclusion of titanium dioxide additives. Although this has the above identified drawbacks associated with arc resistance properties, the impact is minimized because third insulation layer 26 is so small relative to the overall thickness of secondary insulation layer 24.

In another embodiment of the present invention, as shown in FIG. 3, an additional internal fusion coating layer 23 may be added between primary insulation layer 22 and secondary insulation layer 24. In this arrangement, after using the PTFE coated polyimide tape for primary insulation layer 22, as with the above examples.

Thereafter, a fusion coating layer 23 is applied over primary insulation layer 24. This inner fusion coating layer 23 is preferably applied in multiple iterations, where each iteration is preferably substantially 0.0001″-0.0005″ in thickness. Each application iteration may be in the range of 0.00005″-0.001″. Inner coating layer 23 is advantageously arranged to covers and seal primary insulation layer 22 while at the same time providing smooth and edgeless surface as a base for secondary insulation layer 24. This improves the overall smoothness of the outer surface of cable 10. After the application of inner coating layer 23, secondary insulation layer 24 and fusion coating layer 26 may be applied as above.

As such, according to the above described embodiments, outer fusion coating layer 26 provides an opportunity for wire 10 designers to have an optimum formulation that allows for good laser contrast levels used for marking. The high laser print contrast level on the surface of wire 10 is highly desirable in the industry. By moving the additives into a thinly applied third insulation layer 26, such as one applied by fusion coating, leaving secondary insulation layer 24 as a pure PTFE tape, wire 10 is able to maintain this maximum laser contrast level without losing the “Wet Arc Resistance” performance. Third insulation layer 26 also provides the surface smoothness to wire 10 which is also highly desired in the industry.

The separation of the marking components into a thin fusion applied third insulation layer 26 from the underlying secondary insulation layer 24 made from PTFE tape also allows designers of wire 10 additional freedom to explore new wire designs with unique properties.

For example, one such performance attribute is the “dynamic cut-thru” performance wire. The “dynamic cut-thru” performance, designed to measure the ability of a cable or wire insulation to resist being cut by a sharp edge and thus shorting in an in-service environment, is primarily determined by amount of polyimide material present in the insulation 20, such as in primary insulation layer 22. However, polyimide material is a detriment to the “Wet Arc Resistance” performance of cable 10, thus necessitating the PTFE coating on primary tape as well as secondary insulation layer 24. With arrangement of the present invention, which has greatly improved “wet arc resistance” performance because of the pure PTFE secondary insulation layer 24, the polyimide component in primary insulation layer 22 may be increased in order to increase the mechanical property of the insulation (i.e. dynamic cut-thru) while still meeting the “wet arc resistance” performance standards. This flexibility is not possible with current existing wire system, such as those specified in AS22759/80-/82, /86-/92 and BMS-1360.

Another advantage of the present invention is that that the separate and discrete design of the secondary insulation layer 24 of pure PTFE tape and the thin third insulation layer 26 provides freedoms to use alternative fluoropolymers in third layer 26 in wire 10 such as PFA (Perfluoroalkoxy), MFA (Perfluoromethylvinylether), ETFE (Ethylene Tetrafluoroethylene or Tefzel™), and FEP (Fluorinated Ethylene Propylene) to achieve better abrasion and dynamic cut-through resistant properties while maintaining desirable arc-tracking performance. The discrete coating layer 26 also allows engineers to design a formulation using nano-fillers in this layer without the problem of fully exfoliating the nano-fillers (nano fillers are often agglomerated, and difficult to disperse in compounding process) which could further improve this fusion coating layer 26 regarding its own mechanical, thermal mechanical, and flame performances while maintaining the good arc-resistance based on the primary and secondary layers 22 and 24.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A wire, said wire comprising:
a conductor;
a primary insulation layer;
a secondary insulation layer; and
a third insulation layer, said third insulation layer applied over said secondary insulation layer, wherein said third insulation layer includes the only marking/color additives used in the three insulation layers of said wire.

2. The wire as claimed in claim 1, wherein said conductor is formed from a plurality of stranded conductor elements.

3. The wire as claimed in claim 1, wherein said primary insulation layer is formed from a polymer tape

4. The wire as claimed in claim 3, wherein said polymer tape is a tape having a polyimidie core.

5. The wire as claimed in claim 4, wherein said polyimide core is coating on at least one side by a fluoropolymer.

6. The wire as claimed in claim 3, wherein said primary insulation layer is formed from a polymer tape that is helically wrapped around said conductor at substantially 5%-75% overlap.

7. The wire as claimed in claim 1, wherein said secondary insulation layer is formed from a polymer tape made of pure PTFE, without any additives.

8. The wire as claimed in claim 7, wherein said secondary insulation layer is formed from a polymer tape that is helically wrapped around said conductor at substantially 5%-75% overlap.

9. The wire as claimed in claim 7, wherein said secondary insulation layer is formed of a polymer tape of substantially 0.0005″-0.004″ in thickness.

10. The wire as claimed in claim 1, wherein said third insulation layer is applied such that the resulting outer surface of said wire is smooth.

11. The wire as claimed in claim 1, wherein said third insulation layer is formed in consecutive layering steps, each step applying a coating of substantially 0.0001″-0.0004″.

12. The wire as claimed in claim 1, wherein said third insulation layer is formed of a polymer selected from the group consisting of, PTFE, modified PTFE, PFA, MFA, ETFE and FEP.

13. The wire as claimed in claim 12, wherein said third insulation layer further includes UV laser marking additives.

14. The wire as claimed in claim 12, wherein said third insulation layer further includes coloring additives.

15. The wire as claimed in claim 1, further comprising an internal coating layer between said primary insulation layer, and said secondary insulation layer.

16. The wire as claimed in claim 15, wherein said internal coating layer is applied in multiple iterations, each of which is substantially 0.0001″-0.0004″.

17. The wire as claimed in claim 15, wherein said internal coating layer is formed of a polymer selected from the group consisting of, PTFE, modified PTFE, PFA, MFA, ETFE and FEP.
